(19) United States
(12) Patent Application Publication
(10) Pub. No.: US 2010/0051626 A1
(43) Pub. Date: Mar. 4, 2010

(54) Cooking device and method with improved temperature control

(76) Inventors: In Chel Moom, Kimpo-city (KR); Jason Ryu, Palisades Park, NJ (US)

Correspondence Address: RYNDAK & SURI LLP, 200 W. MADISON STREET, SUITE 2100, CHICAGO, IL, 60606, US

(21) Appl. No.: 12/381,760

(22) Filed: Mar. 16, 2009

Related U.S. Application Data
(60) Provisional application No. 61/069,415, filed on Mar. 14, 2008.

(51) Int. Cl. A47J 27/00

(52) U.S. Cl. 220/573.1

(57) ABSTRACT

Cookware and cooking methods with improved temperature control. The temperature of the cooking surface of the cookware is limited by providing an air channel to allow heated air to circulate between layers of conductive material in the base of the cookware and an air ventilating hole to allow excessive hot air to escape. The cookware may also have a plurality of layers of conductive material such as metal interspersed with one or more layers of a mineral such as jade or other heat-radiating materials. This cookware structure permits heating or cooking food at a controlled temperature, even without the presence of water or other liquid, over a long period of time while maintaining the temperature within the desired range.

### CROSS-REFERENCE TO RELATED APPLICATION

This application claims the benefit of U.S. Provisional Application No. 61/069,415 filed on Mar. 14, 2008.

### FIELD OF THE INVENTION

The present invention relates to cooking devices and methods with improved temperature control. In particular, it relates to cookware that limits the temperature of the cooking surface of the cookware by providing an air channel to allow heated air to circulate between layers of conductive material in the base of the cookware and an air ventilating hole to allow excessive hot air to escape. The cookware may also have a plurality of layers of conductive material such as metal interspersed with one or more layers of a mineral such as jade or other heat-radiating materials.

### BACKGROUND OF THE INVENTION

Conventional cookware is generally composed of a container having vertical sidewalls extending upwardly from a bottom wall, one or more handles, and, optionally, a lid. At least the bottom wall is made of a heat conductive material such as metal to transfer heat from the lower surface of the bottom wall from a heat source such as a stovetop burner to food placed on the top surface. High-quality cookware in which heat is transferred uniformly throughout the conductive heat cooking surface, for example iron, aluminum and copper cookware, are also well known for cooking. Such cookware often includes a non-stick coating on the top surface of the metal cooking surface to prevent food or food residue from adhering to the surface.

Many foods such as eggs and vegetables are boiled because boiling maintains the maximum temperature of the food at the boiling point of the liquid used, such as water at 100° C., to provide even cooking and prevent overcooking. It is often desirable, however, to cook foods with little or no water to avoid loss of nutrients in the food being cooked. It is also desirable to cook food with little or no cooking oil to reduce fat consumption. No current designs of cookware allow the maintenance of the temperature of the cookware over time without overheating without the presence of a liquid such as water or oil. Overheating can lead not only to the loss of nutrients in the food being cooked, but damage to the non-stick coating or even the cookware itself. No current designs allow for cooking without liquid repeatedly, while maintaining any non-stick qualities on the cooking surface.

Foods may also be fried in hot oil such as vegetable oil. The boiling point of vegetable oil is about 150° C., and restaurants usually fry food in oil at temperatures between 150° and 180° C. If the temperature of the oil is too hot, toxins such as acrolein may be introduced.

### SUMMARY OF THE INVENTION

The invention describes a device and method for heating materials or cooking food at a controlled temperature, even without the presence of water or other liquid. The invention allows the heating of cookware and its contents over a long period of time while maintaining the temperature within the desired range.

### BRIEF DESCRIPTION OF THE DRAWINGS

FIG. 1 is a cross-sectional view showing the layers of an embodiment of this invention and includes a zoom view of the layered cross section.

FIG. 2 is a cross-sectional view showing the layers of three embodiments of this invention (e.g., sauce, multi-purpose and roasting pans).

FIG. 3 displays one embodiment of the air ventilating hole of the invention.

FIG. 4 displays one embodiment of the pan base structure adapted for use on a magnetic induction range.

FIG. 5 is a cross-sectional view of a pan in accordance with the invention showing the air flow.

FIG. 6 is a graph showing the temperature of an embodiment of the invention over time, using a medium fire and strong fire for comparison.

FIG. 7 is a graph showing the temperature of an embodiment of the invention over time.

FIG. 8 shows a detachable handle for an embodiment of this invention.

FIG. 9 is a perspective view of an embodiment of a cooking pan of the invention having a grease-draining feature.

FIG. 10 is a cross-sectional view of the pan of FIG. 9.

### DETAILED DESCRIPTION OF THE INVENTION

The invention is useful in a variety of different types of cookware, such as saucepans, frying pans, multi-purpose pots and pans, roasting pans, etc. Examples of different shapes and sizes of cookware are shown in FIG. 1. The cookware may be used for cooking food with little or no added liquid (water or oil), or may be used to control the temperature of the cooking liquid when boiling food in water or frying it in oil.

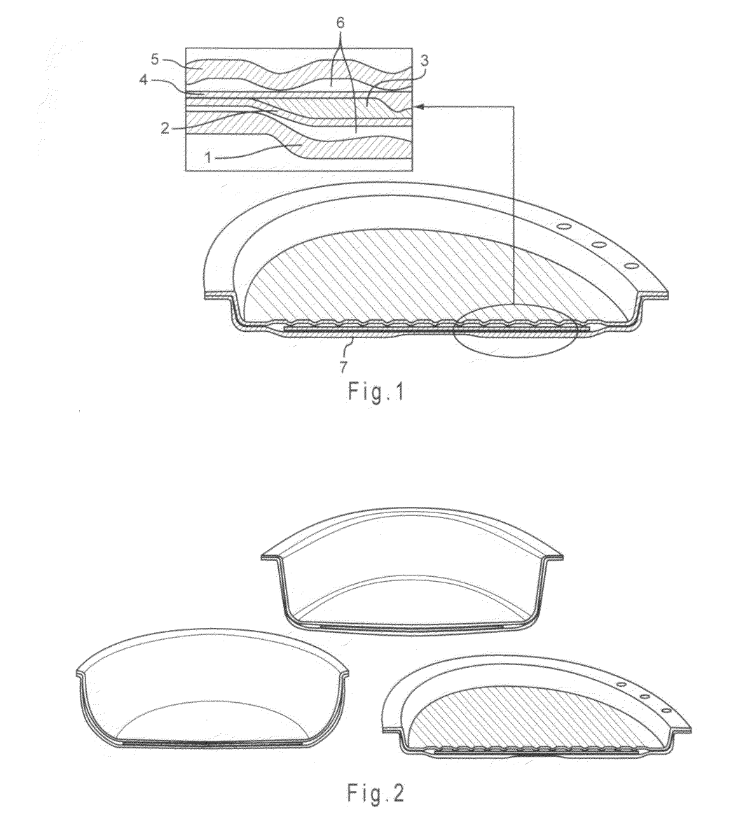

In one embodiment, the cookware is a pan (see FIGS. 1 and 2) for use on a suitable heat source, such as a stove or grill. The pot or pan may be adapted for use on a conventional gas or electric range or on other types of cooktops. For example, the pan can be adapted for use on a magnetic induction range by modifying the base of the pan as shown in FIG. 4. The pan can be in any suitable shape, such as a sauce, multipurpose or roasting pan (see FIG. 2).

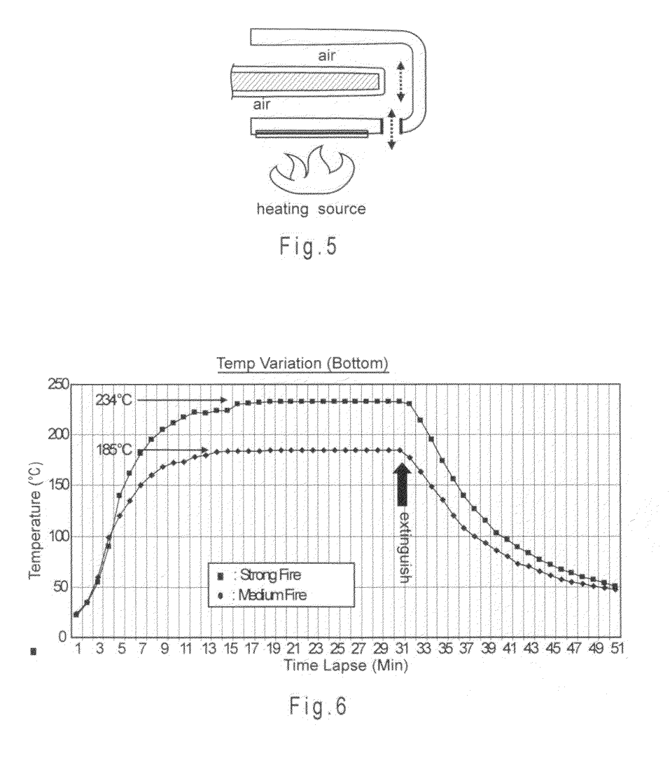

As shown in FIGS. 1, 2 and 5, the cookware of the invention has a multilayer structure in order to facilitate heat transfer and control. As best seen in the schematic view of FIG. 5, there is a first layer of conductor 10, which is heated directly by being placed on the heat source 11. The conductor can be any material suitable for the temperature range desired, such as aluminum, copper, etc. Above the first layer of conductor 10 is a first layer of air 12. Above the first layer of air 12 is a second layer of conductor 13. The second layer of conductor 13 may contain or be wrapped around a layer of infrared emitting material 14, such as a mineral, preferably jade. Jade, which may be in the form of jade powder, has been found to be an efficient radiator of infrared rays and is cost effective. Above the second layer of conductor 13 (with or without mineral layer 14) is a second layer of air 15. Above the second layer of air 15 is a third layer of conductor 16, whose upper surface forms the cooking surface of the cookware. The first layer of air 12 and the second layer of air 15 are preferably connected by an air layer connecting channel or passage 17 that allows air to flow between the layers of air 12, 15. More layers of the conductor and infrared emitting materials may be incorporated as desired. The conductor layers may be flat or may be contoured or have undulations as shown in FIG. 1. A non-stick coating of a material such as Teflon® is preferably provided on the cooking surface.

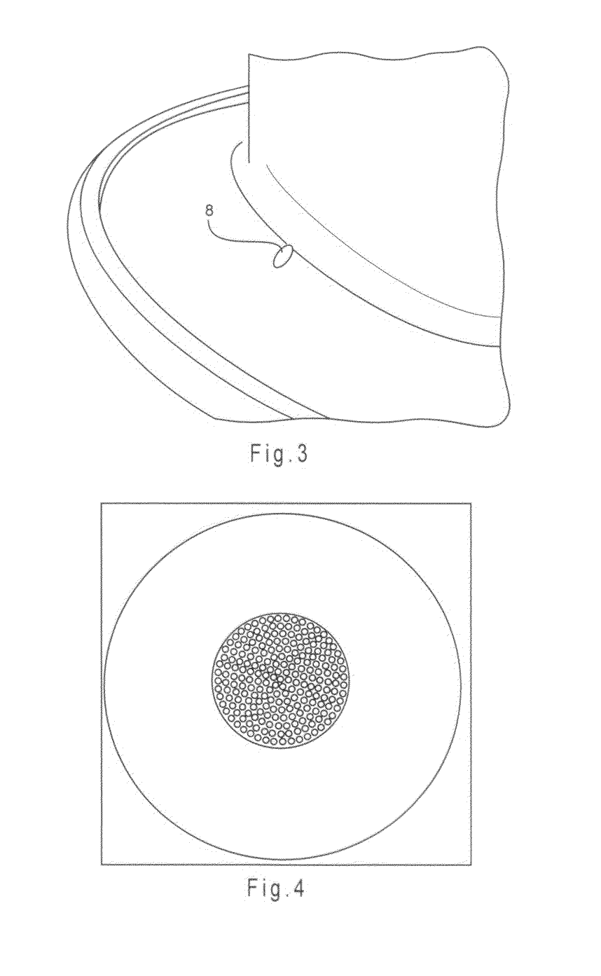

At least one air ventilating hole 8 (as shown in FIGS. 3 and 5) is provided to allow the escape of heated air from the air layers between the conductor layers to the outside environment. In the embodiment shown in the FIG. 5, air ventilating hole 8 is located in the lower surface of the first conductor layer 10, but air ventilating hole 8 may be placed at any suitable location, such as for example the side of the pan, the handle, or the base. One or more air ventilating holes may be provided. The presence of an air layer connecting channel 17 allows air to circulate through the upper and lower air layers 12, 15 between the conductor layers of the pan. As the air temperature between the conductor layers increases, so does the air pressure in the air layers. The air ventilating hole 8 allows the excess heated air under pressure to escape.

In another embodiment, a pan can have a five layer structure 7 as shown in FIG. 1. There is air 6 between a first layer of aluminum 1 and a second layer of aluminum 2. There is next a third layer 3 of mineral powder, preferably jade powder. Finally, there is 6 air between a fourth layer of aluminum 4 and a fifth layer of aluminum 5. The aluminum layers are able to release heat to the air layer(s) with which each is in contact. Any heat the mineral powder transfers through direct contact or via infrared radiation will be absorbed by the aluminum layers surrounding it, and then can be transferred to the air. Therefore, if the base of the pan becomes overheated, hot air is vented out through the air ventilating hole to the outside ambient air, thus preventing overheating and maintaining the desired temperature. The combination of conductor layers, at least one air layer, at least one air ventilating hole, and, preferably, at least one air layer connecting channel (and preferably at least one mineral layer) modulates the temperature of the cooking surface.

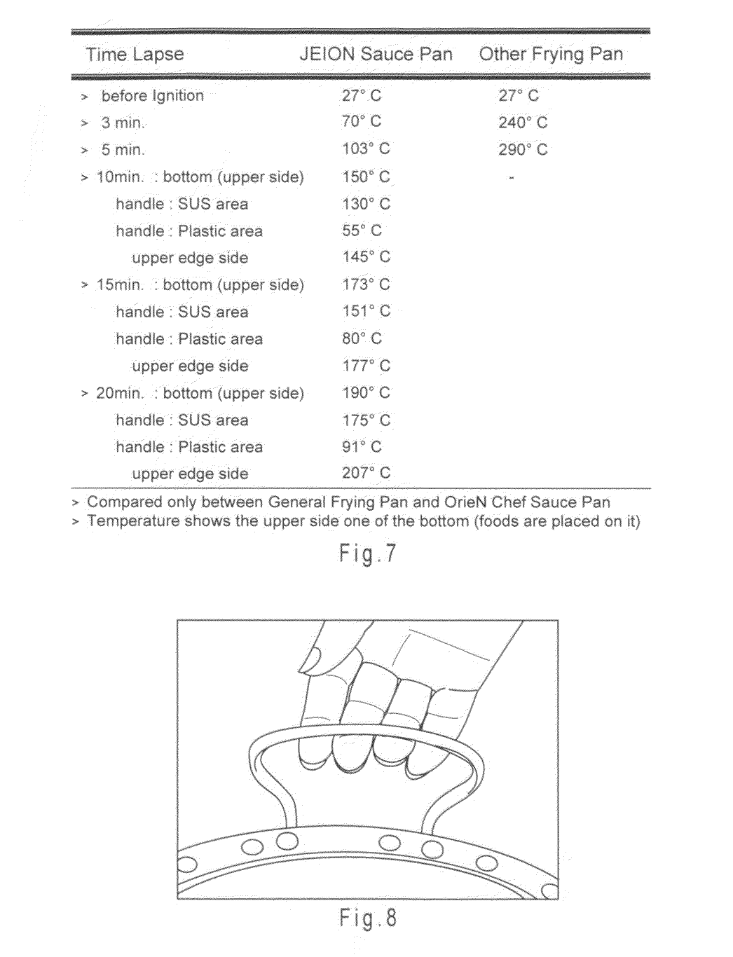

Tests have demonstrated the effectiveness of the invention. The results of temperature measurements at the base of a pan in accordance with the invention are shown in FIG. 6. Note that once the desired cooking temperature is reached, the temperature of the pan remains relatively constant over time without increasing further. Other tests showed that an embodiment of the invention (the “JEION” pan) maintained a much lower temperature of oil over time as compared to a conventional frying pan, which rapidly became much hotter than the desired range of frying temperatures (see FIG. 7).

The cookware may have one or more conventional fixed handles, but preferably the handles are easily detachable by the user for convenient storage of the cookware in less space. For example, the handles may be loops whose free ends are inserted into holes in the rim of the cookware, as shown in FIG. 8.

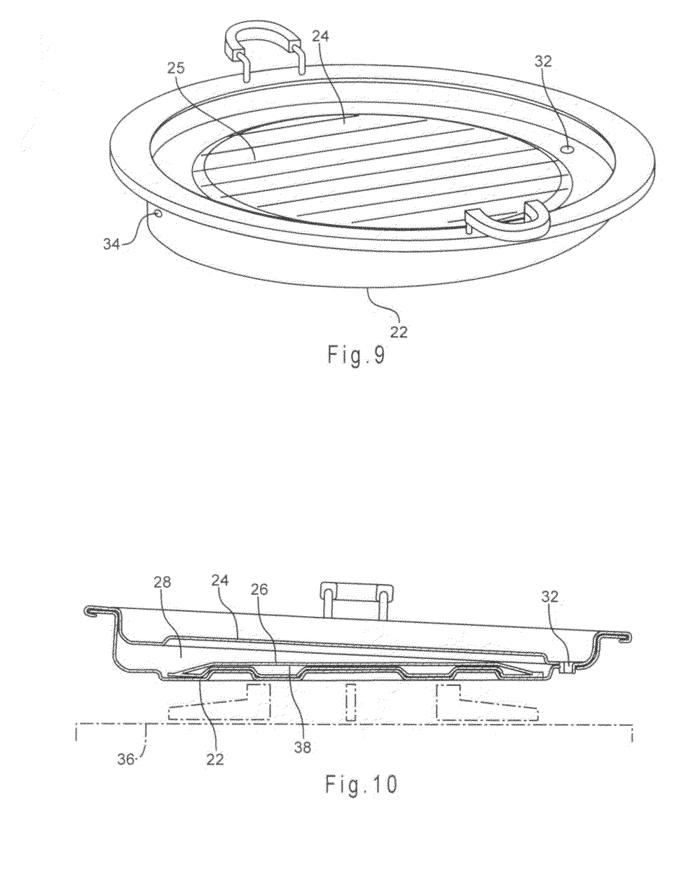

The multi-layer design of the cookware permits an additional feature as shown in FIGS. 9 and 10. The upper conductor layer 24, the upper surface of which forms the cooking surface, is preferably slanted and has ribs 25 on the cooking surface to permit grease and oil to drain toward one side of the pan. A draining hole 32 is provided at the lower side of the cooking surface so that excess grease and oil may drain through draining hole 32 to a separate collection cup (not shown). A removable plug made of a heat-resistant material such as silicone may be provided to plug draining hole 32, if desired. This draining feature is possible due to the multi-layer construction of the pan, which permits the lower surface 22 of the pan to sit flat (horizontal) on the cooktop 36 while the upper surface 24 is slanted to allow grease and oil to flow to draining hole 32. The multi-layer construction is similar to that described above, with three layers of conductors 22, 24 and 26, a layer of infrared emitting material 38 such as jade, and an air layer 28. An air ventilating hole 34 is provided on the high side of the pan (i.e., generally opposite the side with grease draining hole 32) to allow the escape of heated air from air layer 28. This pan is especially suited for cooking foods such as steak or fish, and allows easy healthful, low-fat cooking.

While the invention has been described with respect to certain preferred embodiments, as will be appreciated by those skilled in the art, it is to be understood that the invention is capable of numerous changes, modifications and rearrangements.

We claim:

1. A cooking vessel having a multi-layer base comprising:
a first heat conductor layer;
a second heat conductor layer;
a third heat conductor layer;
an air layer located between the first and second heat conductor layers;
an infrared emitting material located between the second and third heat conductor layers; and
an air ventilating aperture located in the air layer.
